(19) United States
(12) Patent Application Publication
(10) Pub. No.: US 2005/0189204 A1
(43) Pub. Date: Sep. 1, 2005

(54) Microengineered broadband electrical switches

(76) Inventors: Eric Yeatman, London (GB); Richard Syms, London (GB)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/038,619

(22) Filed: Jan. 18, 2005

(30) Foreign Application Priority Data
Jan. 22, 2004 (GB) GB0401408.0

(51) Int. Cl. H01H 57/00

(52) U.S. Cl. 200/181

(57) ABSTRACT

A MEMS switching device including a first and second actuator and a switching member is described, the switching member being adapted to selectively provide a signal path between a first and second signal line. The selective provision of the signal path is effected by movement of a switching member from a first position to a second position, the movement of the switching member being effected by action of the first and second actuators thereon, such action resulting from a deformation of the actuators. In one embodiment of the invention, catch mechanisms link the switching member to the substrate in a first position, such that the switching member is maintained in this position when the actuation force is removed, and can be released by deformation of one actuator. In another embodiment of the invention, catch mechanisms are provided to maintain the switching member in each of two positions, and single actuators for each of the two positions provide both release of the catch mechanism for that position and translation of the switching member to the other position. In each embodiment, actuators are electrically disconnected from the switching elements other than during change of the switch position, so that interference between the switched signal path and the control circuits is avoided.

### FIELD OF THE INVENTION

The invention relates to switches and in particular to switches applied or manufactured using micro-electro-mechanical systems (MEMS) technology. More particularly the invention relates to low loss electrical switches.

### BACKGROUND OF THE INVENTION

One of the expanding applications of micro-electro-mechanical systems (MEMS) technology is in the area of low loss electrical switches. These switches are essentially miniaturised electromechanical switches or relays, and can be utilised to switch signals with frequencies from DC to above 40 GHz rapidly, efficiently and with minimal loss. The main alternative approach for highly miniaturised electrical switching is the use of solid-state technology. This relies on diodes or MESFETs which typically incur a 1 to 2 dB loss per switch depending on frequency and also, particularly in the case of diodes, have a high power consumption. MEMS switches typically exhibit low signal losses, and the power required to operate the switch may be minimal. The high loss and power requirements using diodes or MESFETs significantly limit the application of solid state switch based components, and sub-systems (phase shifters, etc.) based on them.

Much work has been undertaken to fabricate and demonstrate MEMS switches. Examples exist of vertical and horizontally actuated switches, and numerous techniques have been used to fabricate them. Goldsmith in U.S. Pat. No. 5,619,061 describes the fabrication of a switch in the form of an electrostatically actuated dielectric diaphragm formed from silicon nitride (SiN) with metal electrodes. In its rest position low capacitance results in high isolation. When closed by the application of a drive voltage, high capacitance results and capacitive coupling allows the signal to pass. This approach can be adequate for the switching of radio frequency (RF) signals, but for switching of low frequency signals, direct ohmic contact of the switch parts is necessary.

Berenz in U.S. Pat. No. 6,069,540 describes a vertically actuating switch mechanism that pivots on a central point that also acts as the input for an RF signal. Electrostatic actuation is used to pull the metal cantilever, which acts as the transmission line, down on one side or the other where ohmic contact is made enabling the signal to pass. Isolation from the actuation electrodes is provided, as the switch contact is itself isolated from the actuation electrodes. Bozler in U.S. Pat. No. 6,127,908 describes a switch formed by the use of anisotropic stress to form a cantilever that is designed to bend away from the substrate. Strategically placed electrodes and contacts are used so that when electrostatic actuation is applied it pulls the cantilever down flat. Designs can be varied to cater for both ohmic and capacitative coupling.

Laterally (or horizontally) moving switches, where the motion is parallel to the plane of the substrate of the device, allow great flexibility in MEMS switch geometries, since patterning in the lateral dimensions is done by photolithography which can provide geometric complexity without correspondingly increased manufacturing complexity or cost. The previously cited examples are all vertically actuated devices, using parallel plate electrostatic actuation. Yao describes a horizontally actuated device using an electrostatic comb drive in U.S. Pat. No. 6,074,890. This patent describes a tuneable capacitor with the comb drive formed in the device layer of a silicon-on-silicon wafer. Residual silicon oxide (SiO₂) anchors the fixed comb drive and the control electrode is isolated from the part linking the signal lines by the use of a SiN mechanical coupler. The moveable comb drive is free to move with the removal of the underlying SiO₂ and is supported by a suspension mechanism fixed to anchor points.

This device illustrates an important issue in micromechanical switches. In many designs, one or more control voltages is connected to the same electrically conducting part as one of the signal lines. This may result in interference between the control and signal circuits. Also, for RF signals the line impedance must be continuous at the switch or an unwanted signal reflection will result. If the control circuit is electrically linked at the switching point, it will appear as an electrical load, causing an impedance mismatch and thus a reflection. This problem is more difficult to overcome for laterally moving switches, where the suitable materials for the mechanical parts tend to be conductors (metals or silicon). In U.S. Pat. No. 6,074,890, the problem is avoided by linking two conducting sections of the moving switch part with a non-conducting linking section, providing some isolation between signal and control circuits. However, this link adds greatly to the fabrication complexity, and may compromise the reliability of the device by adding additional modes of failure (for example mechanical breakage at the linking section).

Laterally moving switches have also been described in which the actuation mechanism IS thermal, rather than electrostatic. Thermal actuators can provide high forces without requiring the high drive voltages typically demanded by electrostatic actuators. However, unlike electrostatic actuators they consume significant amounts of power when actuated. Therefore, they are unlikely to be acceptable unless this power consumption is confined to the period when the switch is actuated from one state to another, rather than being present when the switch is held in one state. Another method for maintaining the state of the switch is thus required. One approach is reported in patent WO 02/058089. Here the bridging part of the switch is attached to a mechanically bistable mechanism, consisting of a beam anchored at both ends and bowed laterally between the ends. This beam may be pushed by an actuator so that it bows in the opposite direction, and will be stable in that position until pushed back towards its original position. There are, however, several difficulties with this design. One is that, since the beam is fabricated in the first bowed position, it is more stable in that position than in the other. In order to get sufficient stability in the second state (which will be the “on” state), the beam must be designed with a very high stability in the first state, so that the required actuation force will be high. Also, achieving sufficient displacement between the two states, and reasonable actuation forces, requires a very long beam, and this increases the size of the overall device. Another method of maintaining the state of the device is to use mechanical latches, as described in U.S. Pat. No. 6,407,478B1. Here two thermal cantilever actuators are used to open and close the switch, which by applying the correct sequence of control voltages can be made to latch together mechanically, in order to maintain either state.

For RF applications, the bistable design has the advantage that the bridging part, i.e. that which forms the link between the two signal lines when the switch is in the closed (or “on”) state, can be physically separate from the actuator that moves it, so that the actuator is only in physical contact during the switching operation, but not while the switch remains in the closed or open state. This can provide isolation between the control and signal circuits while the switch is maintained in one state. However, there are difficulties with this design, as stated. There is therefore a need to provide an improved MEMS switch that provides isolation between the control and signal lines and can be implemented using thermal actuation.

### SUMMARY OF THE INVENTION

Accordingly, the present invention provides an electrically controlled micro-mechanical switch, suitable for fabrication by MEMS technology, for use in switching low frequency or radio frequency (RF) signals over a wide frequency range. In accordance with the invention, a laterally actuated micro-electromechanical switch is provided which is suitable for thermal actuation, and suitable for high and low frequency signals, in which the control and signal circuits are well isolated from each other. The invention achieves switching by use of a bridging element which is held in position by latch mechanisms. The bridging element or switching member is supported on a cantilevered beam which is physically distinct and separate from the actuators. Thus the need for bi-stable mechanisms is avoided, while separation of switch parts and actuation parts is still achieved. A switch in accordance with the invention provides a high level of electrical isolation between the signal circuit, i.e. the circuit carrying the signals to be switched, and the control circuit, i.e. that carrying the signals controlling the state of the switch. It is also a feature of preferred embodiments of the invention that the switch will remain in either its open or closed position without the application of holding signals or the consumption of electrical power by the mechanical actuation mechanisms.

These and other objects, advantages and features of the present invention may be provided by preferred micromechanical devices that include a substrate onto which are attached conductive parts which, when in contact or close proximity with each other, provide a low impedance path between two or more signal lines also provided. The conductive parts include a plurality of cantilevered structures which are mechanically fixed to the substrate at one end, but are free to move at the other end when deformed, in a motion primarily parallel to the surface of the substrate. Desirably, three such structures are provided, one of these structures acting as a switching element, and two or more of the structures acting as actuators. When they are in their relaxed state, these structures are not in electrical or mechanical contact with each other, or with the signal lines, and a high impedance results between the signal lines. Deformation of the actuators is caused by differential thermal expansion, where as a result of a difference in temperature change or thermal expansion coefficient between different parts of a structure, heating causes the structure to bend. A low impedance connection between the signal lines is made by one of the actuator structures being deformed in this way, such that the switching element is displaced by this actuator structure into a position either of direct contact or of close proximity to the signal lines, and the switching element is held in such a position by a latching mechanism.

Opening of the switch of the present invention is effected by the deformation of a second actuator structure in the manner described above, so that the switching element is both released from the latching mechanism and moved to a second position. This second position may be the rest position where the switching element is unlatched, or a second latched position, where the switching element may be removed from all signal lines, or may effect a different connection than that effected in the first latched position. In the case of the second position being latched, deformation of the first actuator may effect release of the second latch mechanism, as well as displacement of the switching element into the first latched position.

A further form of the invention is one in which the cantilever supporting one or more switching elements has two latched positions. This may be so as to provide two different signal path connections, as in a single pole double throw switch, or to ensure that the switch in the open state is not subject to shock-or vibration-induced motion of the switch element. In order to avoid the complexity, and increase in device size, associated with providing separate actuators for release of each of the catch mechanisms and for displacing the switch element cantilever into each of its latched states, the invention provides for single actuators to effect both catch release and displacement into the other latched state.

A preferred embodiment of the invention provides a MEMS switching device comprising a substrate and having at least one actuator and a switching member mounted thereon, the switching member adapted to selectively provide a signal path between a first and second signal line, and wherein the selective provision of the signal path is effected by movement of the switching member from a first position where the first and second signal lines are electrically isolated from one another and a second position where the switching member moves so as to provide a signal path between the first and second signal lines, the movement of the switching member being effected by a deformation of the at least one actuator.

The invention also provides a method of manufacturing such devices as well as a packaged device incorporating one or more switching devices.

These and other features of the present invention will be better understood with reference to the following drawings.

### BRIEF DESCRIPTION OF THE DRAWINGS

FIG. 1 is a plan view of a preferred embodiment of the invention in the open state, showing the two cantilevered actuator structures, the switch element on its cantilever support, the catch mechanism, the signal lines, and the electrical terminals of the control circuit.

FIG. 2 shows the same mechanism with the switching part in the closed and latched state, with one actuator structure in the non-relaxed state used to effect this position of the switch.

FIG. 3 shows a switch, in an initial as-fabricated position, with catch mechanisms provided for both positions of the switching element cantilever.

FIG. 4 shows such a switch in a first latched position, with a low impedance connection made between two RF signal lines.

FIG. 5 shows such a switch during the switching operation, with an actuator having released one set of catches and in the process of displacing the switching element cantilever towards a second latched position.

FIG. 6 shows a switch providing a single-pole double-throw function, where a different signal line connection is made in each of two latched positions of the switching element.

FIG. 7 show a detail of the switching element, showing a flexible link allowing the element to rotate to the orientation in which the conducting surface of the element is parallel to those of the signal lines.

FIG. 8 shows a generic elevation view of a preferred embodiment, indicating the vertical construction of a device.

FIG. 9 shows a switch with two latched positions, in which the switching element is supported by two portal frames, providing horizontal motion of the switching element.

FIG. 10 shows a switch with two latched positions, in which the switching element is supported by a nested cantilevered extension on a portal frame, for reduced device size.

### DETAILED DESCRIPTION OF THE INVENTION

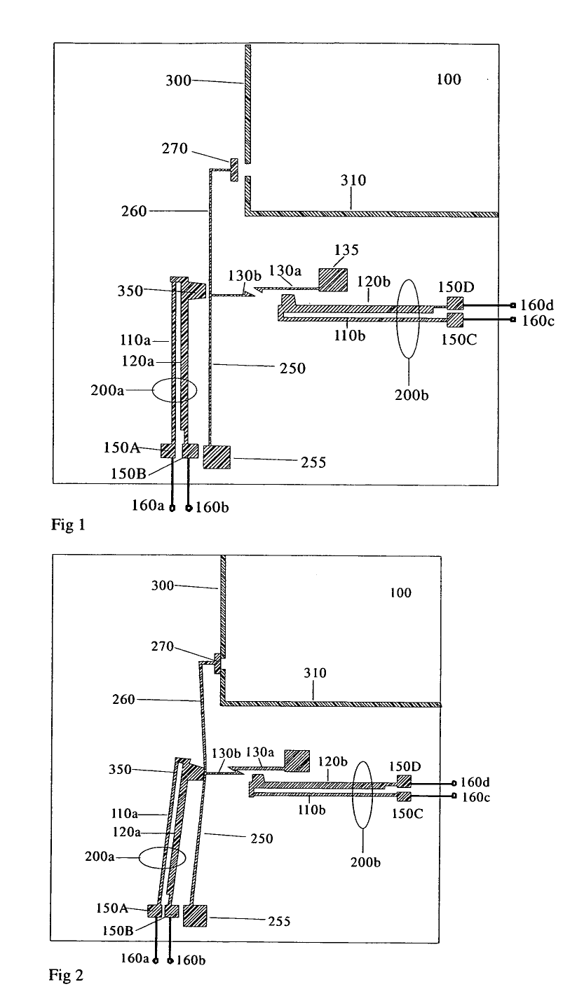

Referring in detail to the drawings where similar parts are identified by like reference numbers, there is seen in FIGS. 1 and 2 a diagram of a single pole single throw RF MEMS switch, in accordance with the present invention, in its open and closed position respectively. The switch is provided on a substrate 100 and is mounted in such a way as to present a number of electrical terminals 160 for connection to a printed circuit board or otherwise for connection to external control circuits. Terminals 160a and 160b provide the connections for passing an actuation current through a first actuator formed as a cantilever 200a. Each external terminal 160 is electrically connected, for example by wire bonding, to a fixed anchor 150, each anchor being a part mechanically fixed to, but electrically isolated from, the substrate. The substrate may be a silicon wafer, or some other planar substrate suitable for processing with semiconductor process equipment such as photolithography tools.

The first cantilever 200a has two parallel members, 110a and 120a, which are mechanically and electrically connected to anchors 150A and 150B respectively at their proximal ends. The parallel members 110a and 120a are connected to each other mechanically and electrically at some distal point, which may be the distal end of one or both of them, although one or both may extend beyond this connection point. The cantilever includes or comprises an electrically conductive layer such that a low resistance electrical path is provided, running sequentially through members 110a and 120a, from anchor 150A to 150B. A second actuator, again provided as a cantilever 200b, includes two parallel members 110b and 120b, which are connected to, and provide an electrical path between, anchors 150C and 150D in the manner of the equivalent members of the first cantilever. Anchors 150C and 150D are connected to external terminals 160c and 160d respectively, in the manner of the connection of anchors 150a and 150b to their corresponding terminals.

A switching member, provided as a third cantilever 250, is anchored to the substrate by anchor 255, which is not electrically connected to the substrate. The third cantilever includes a switching element 270 connected at its distal end which is formed from a conductive material and which provides a low impedance electrical signal path between two signal lines 300 and 310. Cantilever 250 has an attached latch part, 130b, and a second latch part 130a is anchored at its proximal end to the substrate. In the open position of the switch, as illustrated in FIG. 1, the switching element 270 is sufficiently distant from the termination of signal lines 300 and 310 that no appreciable signal can flow from one signal line to the other. The cantilevers 200a and 200b, including the members 110, the latch parts 130 and the part 250, are fabricated such that they are not in mechanical contact with the substrate underneath them, and are only mechanically connected to the anchors 150,255 and 135, and thus indirectly to the substrate. The signal lines are therefore isolated from one another in this first position of the switching member.

A current may be passed through cantilever 200a by the application of a suitable voltage between terminals 160a and 160b. As a result of the electrical resistance of members 110a and 120a, such a current causes heating of these members. This heating causes the members to increase in length. The members are fabricated in such a way that the increase in length experienced by member 110a is greater than that experienced by 120a. This may be achieved in a number of different ways such as by member 110a being narrower than 120a, so that its resistance is greater. The difference in length increase will cause the cantilever 200a to bend, such that it comes in contact with cantilever 250, causing cantilever 250 to displace, and consequently for the catch mechanisms 130 to contact each other. With application of the correct current for sufficient time, the cantilever 200a will displace cantilever 250 past the point where the switching element 270 contacts the signal lines 300 and 310, such that cantilever 250 bends, and the catch parts 130a and 130b engage with each other.

Upon engagement of the catch parts, the cantilever 250 remains mechanically locked in position even after the current between terminals 160a and 160b ceases, such that the switching element 270 also remains held against 300 and 310 by a force resulting from the bending of member 250. A low impedance electrical signal path is now provided between the signal lines 300 and 310. To release the switch, current may be passed between terminals 160c and 160d, which will flow through cantilever 200b. This will cause bending of cantilever 200b in the manner described above. This bending causes the cantilever 200b to make mechanical contact with catch part 130a, such that 130a is displaced and the catch releases, and cantilever 250 returns to its relaxed position. As a consequence of this movement, the electrical signal path between the signal lines is broken.

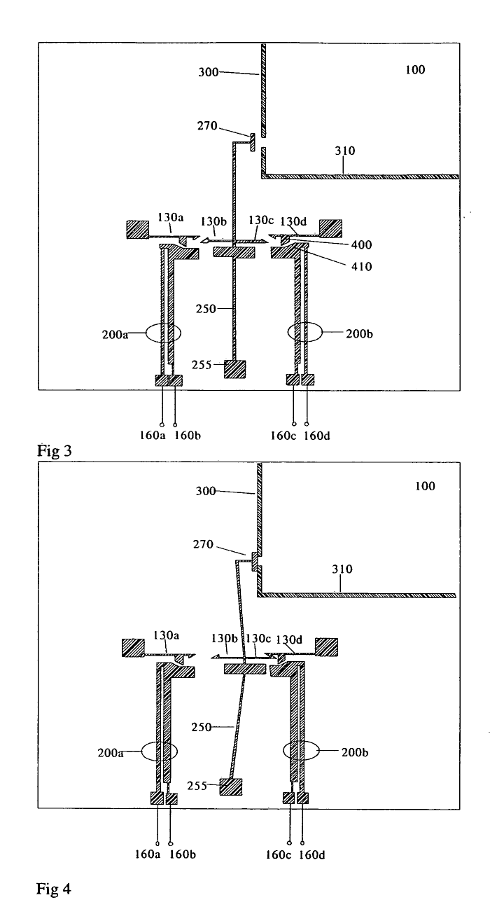

Turning now to FIGS. 3, 4 and 5, a further embodiment of the invention is illustrated, in three different states. In this embodiment each of the two positions of the switching member are maintained by catch mechanisms. In a relaxed, as fabricated state, shown in FIG. 3, the switching member cantilever 250 is in a central position and is unlatched. As shown in FIG. 4, deformation of actuator 200a, resulting from the passing of a current between terminals 160a and 160b, causes the cantilever 250 to displace such that the conductive portion 270 of the switching member 250 first forms a signal path between signal lines 300 and 310. Upon further displacement of switching member 250 to a first latched position caused by further action on it by actuator 200a the catch parts 130c and 130d engage, so as to maintain the position of conductive portion 270, with a holding force on this element or portion caused by the deformation of cantilever 250, when the current between 160a and 160b is interrupted, and cantilever 200a returns to its relaxed position.

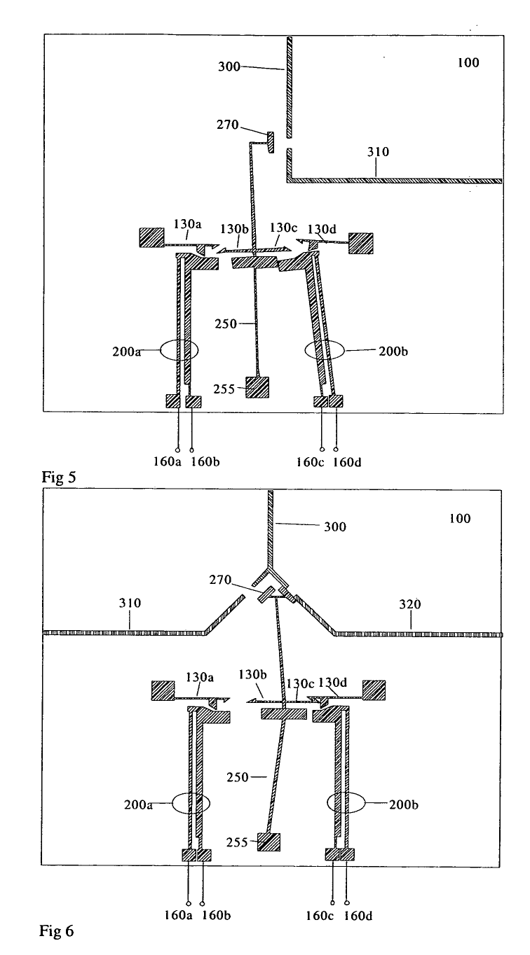

As shown in FIG. 5, deformation of a second actuator or cantilever 200b, by passing a current between terminals 160c and 160d, causes first the unlinking of catch mechanisms 130c and 130d from each other, this resulting from the action of an angled surface 410 on cantilever 200b against an angled part 400 attached to catch mechanism 130d. These shoulders or angled surfaces 400, 410 are brought into mechanical or physical abutment with one another and as a result of the angled geometry between the two are forced apart. Further displacement of 200b then causes the displacement of switching member 250 towards a second latched position, such that the signal path between signal lines 300 and 310 is interrupted, and the catch parts 130a and 130b engage, so as to maintain the position of cantilever 250 when the current between 160c and 160d is interrupted, and cantilever 200b returns to its relaxed position. The switching member is therefore maintained in both its first and second position, i.e. the positions where the signal path is provided and not provided. A current now applied between terminals 160a and 160b causes deformation of cantilever 200a, such that catch mechanisms 130a and 130b are unlinked from each other, and cantilever 250 and conductive element 270 coupled thereto are returned to a first latched position with the signal path again provided between lines 300 and 310.

FIG. 6 illustrates a variant of the embodiment with two latched positions described above. Here the displacement of the switching member cantilever 250 and its associated switching element 270 causes a connection to be made between signal lines 300 and 320, while signal line 310 is electrically disconnected from lines 300 and 320. Deformation of actuator 200b can cause an unlatching of switching member cantilever 250 and translation of switching element 270 to a second latched position, wherein a connection or electrical coupling is made between signal lines 300 and 310, while signal line 320 is electrically disconnected from lines 300 and 310.

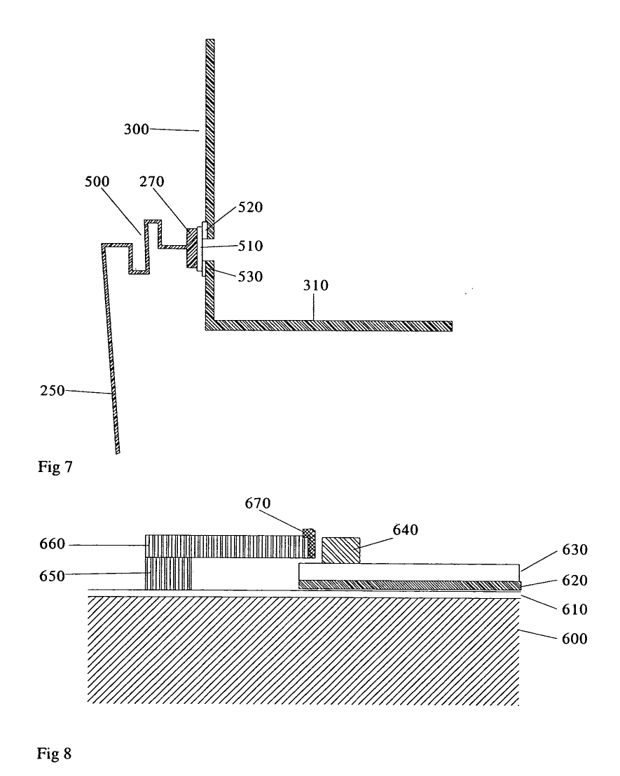

FIG. 7 illustrates a detail of an embodiment in which the switching element 270 is attached to the cantilever 250 though an intermediate meandered beam 500. This detailed view does not include the features of the actuators or the anchoring of the switching member illustrated in the previous drawings. This meandered section gives additional flexibility to the switching element 270 such that it may rotate when pushed against signal lines 300 and 310 by the supporting cantilever 250. In this way the switching element 270 will tend to take up a parallel orientation to lines 300 and 310, such that good contact is made between the contact surface 510 on the switching element and each of the contact surfaces 520 and 530 on the lines 300 and 310.

FIG. 8 shows a generic elevation view of a preferred embodiment, indicating the vertical construction of a device. A substrate 600 such as silicon has superimposed an electrically insulating layer 610 such as silicon dioxide. In the area of the signal lines, a layer 620 to act as a ground plane for the signal lines is superimposed on the insulting layer 610. This layer 620 will be of a conducting material such as gold. Over the conducting layer 620 a dielectric layer 630 is applied, (for example polyimide) over which are attached conducting signal lines 640, again formed from a conducting material such as gold. Adjacent to the areas carrying the signal lines, anchors 650 are formed from a mechanical material such as nickel. Further mechanical layers 660, mechanically attached to the substrate by the anchors 650, form the moving parts of the structure. Conducting surfaces 660, such as gold, are attached to these mechanical parts 650 where required.

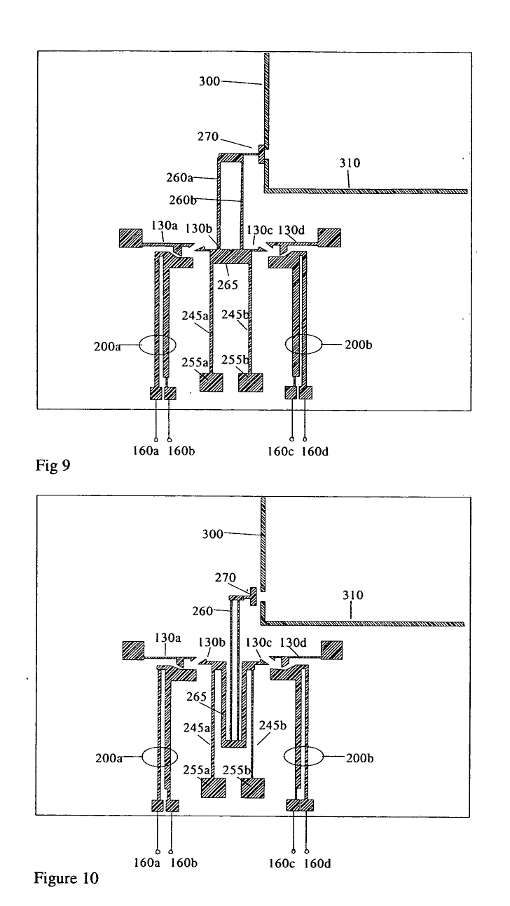

It may be of benefit in embodiments of the invention to support the switching element on a structure that provides it with an approximately linear motion, without rotation. Such a modification to the switching member structure is shown in FIG. 9. The support structure is of a type known as a portal frame, comprising two parallel flexible elements 245a and 245b, supported at one end by anchors 255a and 255b respectively, and attached to each other at the other end by a rigid element 265. This rigid element is constrained by the portal structure to move approximately in a straight line perpendicular to the long axes of the flexible elements 245. The switching element 270 is attached to the element 265 via a second portal frame having two flexible beams 260a and 260b extending from the rigid element 265.

FIG. 10 shows an embodiment in which the size of the switching member structure supporting the switching element is significantly reduced. The switching element 270 is attached to the rigid element 265 via a flexible beam 260, and the rigid element incorporates a recess, such that such that the flexible beam 260 is parallel to the flexible elements 245a and 245b and is adjacent to these along a substantial portion of its length. The operation of the device is similar to that described in FIG. 9, but in this embodiment the geometry of the switching member is such so as to occupy less area on the die of the substrate yet at the same time provide components of sufficient length to enable a sufficient level of flexing. In a similar fashion to that described in FIG. 7, the switching element that is coupled to the portal of FIGS. 9 and 10 may additionally be coupled through an intermediate meandered beam, the meandered beam providing flexibility to the switching element such that it may rotate when pushed against the signal lines by the supporting switching member.

Heretofore the coupling between each of the signal lines provided by the movement of the switching member has been described with reference to the provision of a specific physical contact. It will be understood that for specific RF applications of high frequency, for example in the GHz frequency range, that physical contact between the signal lines is not required as a signal can be conducted through a capacitive link provided between the two signal lines to be coupled. The present invention may therefore be provided in embodiments where the provision of a signal path between signal lines is effected by movement of a conductive portion of the switching member into a proximal position with each of the signal lines, such that a high electrical capacitance is obtained between the switching member and each of the signal lines.

It will be understood that the switching device of the present invention may be implemented or fabricated in anyone of a number of standard methodologies as will be appreciated by those skilled in the art. In one exemplary method of fabrication the device is fabricated as a multi-layer device with base parts for the cantilevers fabricated on one level, the cantilevers on a further level, and the contact surfaces on a further level, each level being formed by the deposition and patterning of a sacrificial polymer layer, for example photoresist, and this layer being used as a mould for the electroplating of the parts in metal. In accordance with standard techniques the polymer layers are subsequently removed.

It will be appreciated that what has been described herein as a preferred embodiment of the present invention is a MEMS switching device including a first and second actuator and a switching member, the switching member being adapted to selectively provide a signal path between a first and second signal line. The selective provision of the signal path is effected by movement of a switching member from a first position to a second position, the movement of the switching member being effected by action of the first and second actuators thereon, such action resulting from a deformation of the actuators. Although the preferred embodiments have been described with reference to two actuators, it will be appreciated that other non-illustrated embodiments of the invention may be provided with only one actuator adapted to effect the movement of the switching member.

Furthermore, although in one embodiment of the invention, catch mechanisms link the switching member to the substrate in a first position, such that the switching member is maintained in this position when the actuation force is removed, and can be released by deformation of one actuator are described such provision of catch members are non essential components of the switching device of the invention and are illustrated as preferred embodiments thereof. Similarly, where catch mechanisms are provided to maintain the switching member in each of two positions, and single actuators for each of the two positions provide both release of the catch mechanism for that position and translation of the switching member to the other position, it will be appreciated that this again is a preferred feature of the invention. In each embodiment, actuators are electrically disconnected from the switching elements other than during change of the switch position, so that interference between the switched signal path and the control circuits is avoided.

It will therefore be understood that although the invention has been described with reference to specific features in each figure that the combination of features described herein is exemplary of the manner in which the present invention may be provided and features or components illustrated in anyone figure may be combined with features of other figures without departing from the present invention. Similarly, the words comprises/comprising when used in this specification are to specify the presence of stated features, integers, steps or components but does not preclude the presence or addition of one or more other features, integers, steps, components or groups thereof. It is not intended that the invention be limited in any way except as may be deemed necessary in the light of the appended claims.

1. A MEMS switching device comprising a substrate and having at least one actuator and a switching member mounted thereon, the switching member adapted to selectively provide a signal path between a first and second signal line, and wherein the selective provision of the signal path is effected by movement of the switching member from a first position where the first and second signal lines are electrically isolated from one another and a second position where the switching member moves so as to provide a signal path between the first and second signal lines, the movement of the switching member being effected by a deformation of the at least one actuator.

2. The switching device as claimed in claim 1, wherein the movement of the switching member is in a plane parallel to a plane of the substrate.

3. The switching device as claimed in claim 1 wherein two actuators are provided, a first actuator adapted to act on the switching member so as to move it to the second position thereby providing the signal path and the second actuator adapted to act on the switching member so as to move it to the first position so as to remove the signal path.

4. The switching device according to claim 1, having a first catch mechanism which is anchored to the substrate, and a second catch mechanism coupled to the switching member and wherein displacement of the switching member to the second position causes the first and second catch mechanisms to become mechanically linked, such that the switching member is maintained in the second position when the actuation force which effected the displacement is removed.

5. The switching device according to claim 4, wherein the release of the linkage between the first and second catch mechanisms is effected by deformation of an actuator, and wherein this release allows the displacement of the switching member from the second to the first position by its own elasticity.

6. The switching device according to claim 4, having additionally a third catch mechanism which is anchored to the substrate and a fourth catch mechanism coupled to the switching member and wherein displacement of the switching member to the first position causes the third and fourth catch mechanisms to become mechanically linked, such that the switching member is maintained in the first position when the actuation force which effected the displacement is removed.

7. The switching device according to claim 6, wherein deformation of a first actuator effects both the release of the linkage between the third and fourth catch mechanisms and the displacement of the switching member from the first to the second position, and wherein deformation of a second actuator effects both the release of the linkage between the first and second catch mechanisms and the displacement of the switching member from the second to the first position.

8. A switching device according to claim 1 including a third and fourth signal line, movement of the switching member selectively providing a signal path between either the first and second signal line or between the third and fourth signal line, such that in the first position of the switching member the first and second lines are electrically isolated from one another and a signal path is provided between the third and fourth lines and in the second position of the switching member the third and fourth signal lines are electrically isolated from one another and a signal path is provided between the first and second signal lines.

9. A switching device according to claim 8, wherein the second and third signal paths are common or electrically coupled to one another.

10. A switching device according to claim 1, wherein each actuator is formed from a cantilever coupled to, but electrically isolated from, the substrate, and having two longitudinal segments, the two segments being electrically connected at the coupled, fixed end of the cantilever to first and second electrical terminals respectively, and the two segments being attached to each other at a point along their lengths, wherein the passing of an electrical current between the first and second electrical terminals causes heating of the first longitudinal segment in such a way as to induce deformation of the cantilever.

11. A switching device according to claim 1, wherein the provision of a signal path by the switching member is effected by physical contact of one or more conductive surfaces on the switching member with one or more conductive surfaces on each of the signal lines for which a signal path is provided.

12. A switching device according to claim 1 wherein the provision of a signal path between signal lines is effected by movement of a conductive portion of the switching member into a proximal position with each of the signal lines, such that a high electrical capacitance is obtained between the switching member and each of the signal lines.

13. A switching device as claimed in claim 1 wherein the switching member includes a switching element, the switching element being rotatably coupled to the switching member such that when the switching member adopts the first position the switching element tends to take up a parallel orientation to the first and second signal lines thereby providing good contact between a contact surface on the switching element and each of contact surfaces on the signal lines.

14. A switching device as claimed in claim 13 wherein the coupling of the switching element to the switching member is effected through an intermediate meandered beam, the meandered beam providing flexibility to the switching element such that it may rotate when pushed against the signal lines by the supporting switching member.

15. A switching device as claimed in claim 1 wherein movement of the switching member is effected by direct action of the at least one actuator thereon.

16. A switching device according claim 1, wherein the switching member includes a switching element coupled to a portal structure, the portal structure providing for linear, non-rotational motion of the switching element.

17. A switching device as claimed in claim 16 wherein the portal structure comprises first and second flexible elements, parallel to each other and each attached at a distal end to a rigid joining element, and each anchored to the substrate at a proximal end.

18. A switching device according to claim 17, wherein the switching element is attached to a third flexible element extending from the rigid joining element of the portal structure, and wherein the rigid joining element includes a recess within which the third flexible element is attached, such that the third flexible element is parallel to the first and second flexible elements and is adjacent to these along a substantial portion of its length.

19. A method of fabrication of a switching device according to claim 10 in which base parts for the cantilevers are fabricated on one level, the cantilevers on a further level, and the contact surfaces on a further level, each level being formed by the deposition and patterning of a sacrificial polymer layer, this layer being used as a mould for the electroplating of the parts in metal, the polymer layers being subsequently removed.

20. A device consisting of a package containing a single die cut from a substrate on which one or more switching devices according to claim 1 have been fabricated, and wherein the one or more switching devices are accessible from terminals of the package.

21. A switching device package comprising a plurality of switching devices, each switching device comprising a substrate having at least one actuator and a switching member mounted thereon, the switching member adapted to selectively provide a signal path between a first and second signal line, and wherein the selective provision of the signal path is effected by movement of the switching member from a first position where the first and second signal lines are electrically isolated from one another and a second position where the switching member moves so as to provide a signal path between the first and second signal lines, the movement of the switching member being effected by a deformation of the at least one actuator.

22. An RF switching device comprising a substrate having at least one actuator and a switching member mounted thereon, the switching member adapted to selectively provide a signal path between a first and second signal line, and wherein the selective provision of the signal path is effected by movement of the switching member from a first position where the first and second signal lines are electrically isolated from one another and a second position where the switching member moves so as to provide a signal path between the first and second signal lines, the movement of the switching member being effected by a deformation of the at least one actuator.
